(19) United States
(12) Patent Application Publication
(10) Pub. No.: US 2025/0251086 A1
(43) Pub. Date: Aug. 7, 2025

(54) FACILITY FOR STORING AND/OR TRANSPORTING LIQUEFIED GAS

(71) Applicant: GAZTRANSPORT ET TECHNIGAZ, SAINT-REMY-LES-CHEVREUSE (FR)

(72) Inventors: Benoît MOREL, SAINT-REMY-LES-CHEVREUSE (FR); Guillaume DE COMBARIEU, SAINT-REMY-LES-CHEVREUSE (FR); Guillaume SALMON LEGAGNEUR, SAINT-REMY-LES-CHEVREUSE (FR)

(21) Appl. No.: 18/856,337

(22) PCT Filed: Apr. 13, 2023
(86) PCT No.: PCT/EP2023/059721

§ 371 Date: Oct. 11, 2024

(30) Foreign Application Priority Data
Apr. 15, 2022 (FR) FR2203564

(51) Int. Cl. F17C 3/02

(52) U.S. Cl. CPC F17C 3/027; F17C 2203/013; F17C 2203/03; F17C 2203/0629; F17C 2205/0355; F17C 2221/013; F17C 2221/014; F17C 2221/016; F17C 2223/0153; F17C 2223/033; F17C 2250/043; F17C 2250/0452; F17C 2270/0107; F17C 2270/0121

(57) ABSTRACT

The invention relates to a facility for storing and/or transporting and/or transferring a liquefied gas, preferentially liquefied hydrogen, said facility having a sealed and thermally insulating container (1) comprising:
a sealed external wall,
a secondary sealed membrane (4) situated at a distance from an inner side of the external wall and defining a secondary space between the external wall and the secondary sealed membrane, said facility having an inerting device (11) connected to the secondary space so as to keep the secondary gaseous phase in the form of a gaseous composition constituted of one or more main chemical species, and optionally one or more secondary chemical species, wherein the partial pressure of the or each main chemical species is lower than the triple point of said main chemical species,
   and wherein the partial pressure of the or each residual chemical species is lower than 0.14 kPa.

### TECHNICAL FIELD

The invention relates to the field of facilities for storing and/or transporting liquefied gas at low temperature. In particular, the invention relates to the field of facilities comprising a sealed and thermally insulating tank for storing and/or transporting liquefied gas at low temperature, such as a tank for transporting liquid hydrogen, which is at approximately −253° C. at atmospheric pressure but can also be stored under a higher pressure. These facilities can be installed at a fixed station or on any onshore or floating vehicle.

### TECHNOLOGICAL BACKGROUND

Facilities comprising a membrane-type tank for storing and/or transporting liquefied natural gas at atmospheric pressure are known. The tank comprises, for example, a tank wall having successively, in the direction of the thickness, from the inside towards the outside of the tank, a primary sealing membrane intended to be in contact with the liquefied natural gas, a primary thermally insulating barrier, a secondary sealing membrane, a secondary thermally insulating barrier and a load-bearing structure defining the overall shape of the tank.

The primary and secondary sealing membranes delimit between them a primary space that contains the primary insulating barrier and that is generally filled with nitrogen so as to avoid the risks of fire in the event of a leak.

Nitrogen also supplies the secondary space defined by the spacing between the secondary sealing membrane and the load-bearing structure.

The sealing membranes of such a tank can have leaks leading to the passage of liquefied natural gas from the inside of the tank towards the primary and/or secondary thermally insulating barriers. Now, when a liquefied gas at low temperature enters the primary space, the primary and secondary spaces are cooled very rapidly.

Document WO2015078972A1 defines a method of sampling for analysis of gas composition in the case of an insulating atmosphere below 10 kPa and preferably below 1 kPa.

Document FR2502289A1 indicates a regulation of the pressure of the secondary space so as to remain higher than or equal to that of the LNG contained in the tank (i.e. around 100 kPa, or even 95 kPa). The LNG contained in the tank is at atmospheric pressure, and this involves a continuous supply of gas that is condensable as soon as a cold point of condensation occurs. The leak is detected by means of monitoring the quantities of gas injected.

### SUMMARY

Certain aspects of the invention are based on the observation that, if the temperature of the primary or secondary space were to drop below the nitrogen liquefaction point, namely −196° C. at atmospheric pressure, the liquefaction of the nitrogen could pose a major problem since liquid nitrogen could flow under gravity, in particular in the secondary space as far as the internal surface of the load-bearing structure. Now, the load-bearing structure is not generally designed to reach such a low temperature and would risk unacceptable weakening.

Thus, there is a need to find a solution that makes it possible to prevent the formation of cold liquid in the primary or secondary space of a facility for storing and/or transporting liquefied gas at low temperature such as hydrogen.

One idea underlying the invention is that of providing a facility that solves the problems mentioned above.

Another idea underlying the invention is that of using essentially carbon dioxide (CO₂) as inert gas in the secondary space of a sealed and thermally insulating tank containing liquefied gas, in particular when said tank contains liquid hydrogen.

Another idea underlying the invention is that of providing a method for inerting the secondary space of such a sealed and thermally insulating tank.

Another idea underlying the invention is that of providing a method for detecting a leak in such a sealed and thermally insulating tank.

To this end, the invention proposes a facility for storing and/or transporting and/or transferring a liquefied gas, preferentially liquefied hydrogen, said facility having a sealed and thermally insulating container, the sealed and thermally insulating container comprising:
a sealed external wall,
a secondary sealed membrane situated at a distance from an inner side of the external wall and defining a secondary space between the external wall and the secondary sealed membrane,
a secondary thermally insulating barrier and a secondary gaseous phase that are disposed in the secondary space, the secondary space being delimited by the external wall, the secondary sealed membrane being borne by the secondary thermally insulating barrier,
a primary sealed membrane situated at a distance from an inner side of the secondary sealed membrane and defining a primary space between the secondary sealed membrane and the primary sealed membrane, the primary sealed membrane being intended to be in contact with the liquefied gas, preferentially liquefied hydrogen, contained in the container,
a primary thermally insulating barrier disposed in the primary space, the primary sealed membrane being borne by the primary thermally insulating barrier,
   said facility having an inerting device connected to the secondary space so as to keep the secondary gaseous phase in the form of a gaseous composition constituted of one or more main chemical species, and optionally one or more residual chemical species,
   the inerting device being configured to keep the secondary gaseous phase at an absolute pressure higher than 10 kPa, wherein the partial pressure of the or each main chemical species is lower than the triple point of said main chemical species,
   and wherein the partial pressure of the or each residual chemical species is lower than 0.14 kPa.

According to a first object, the invention provides a facility for storing and/or transporting a liquefied gas, preferentially liquefied hydrogen, the sealed and thermally insulating container being a sealed and thermally insulating tank, the sealed and thermally insulating tank comprising:
an external wall that is a sealed load-bearing structure,
a secondary sealed membrane situated at a distance from an inner side of the load-bearing structure and defining a secondary space between the load-bearing structure and the secondary sealed membrane,
a secondary thermally insulating barrier and a secondary gaseous phase that are disposed in the secondary space, the secondary thermally insulating barrier being anchored to the load-bearing structure, the secondary sealed membrane being borne by the secondary thermally insulating barrier,
a primary sealed membrane situated at a distance from an inner side of the secondary sealed membrane and defining a primary space between the secondary sealed membrane and the primary sealed membrane, the primary sealed membrane being intended to be in contact with a liquefied gas, preferentially liquefied hydrogen, contained in the tank,
a primary thermally insulating barrier disposed in the primary space, the primary sealed membrane being borne by the primary thermally insulating barrier,
   said facility having an inerting device connected to the secondary space so as to keep the secondary gaseous phase in the form of a gaseous composition constituted of one or more main chemical species, and optionally one or more residual chemical species,
   the inerting device being configured to keep the secondary gaseous phase at an absolute pressure higher than 10 kPa, wherein the partial pressure of the or each main chemical species is lower than the triple point of said main chemical species, and wherein the partial pressure of the or each residual chemical species is lower than 0.14 kPa.

By virtue of these features, the inventors have discovered that using such a gaseous composition in the secondary gaseous phase makes it possible, in the event of a leak of liquid hydrogen, to prevent or strongly limit the formation of cold liquid in the secondary space. Specifically, in response to a drop in temperature at the secondary membrane, the one or more main chemical species initially in gaseous phase can condense into solid phase, in the form of a more or less porous solid, for example in the form of snow or icicles, without passing through the liquid state. In addition, such a solid phase tends to adhere to the location where it is formed, for example the secondary membrane, and does not flow into the secondary space. The risk of reaching the load-bearing structure and/or of creating a thermal bridge through the secondary space is therefore greatly reduced.

The total pressure of the secondary gaseous phase may be equal to atmospheric pressure or a higher or lower pressure, within the limits imposed by the mechanical strength of the sealed membranes. The threshold of 0.14 kPa, which is the triple point of dioxygen, ensures that the residual dioxygen, if appropriate, cannot condense into liquid phase, and this reduces the dangers inherent to liquid oxygen, such as corrosion, oxidation, combustion or explosion.

By virtue of these features, the risk of damage to the load-bearing structure is therefore greatly reduced.

In addition, in the event that a liquid hydrogen leak occurs in the primary space, the one or more main chemical species may pass from the gaseous state to the liquid state on contact with the secondary membrane. This change of state is reflected by a decrease in the pressure since the one or more main chemical species in the solid state are much denser than in the gaseous state. This phenomenon can be used to detect leaks.

According to embodiments, such a facility for storing and/or transporting liquefied hydrogen may have one or more of the following features.

According to embodiments, the inerting device is configured to keep the secondary gaseous phase at an absolute pressure strictly lower than 95 kPa.

This specific range of absolute pressure of the secondary gaseous phase makes it possible to:
keep the gaseous composition in the gaseous state while conserving the turbulent to laminar flow properties in order not to increase the resistance to the free circulation of the gaseous composition in the insulation space that would be caused by the passage towards transient flow regimes with the molecular flow, and
put in place a negative relative pressure in the secondary insulation space with respect to atmospheric pressure in order to make it possible to put in place a detection system regarding the sealing of the external sealed wall by monitoring the rise in pressure beyond a criterion. This criterion could be a threshold maximum pressure not to be exceeded. A person skilled in the art may define this criterion according to the level of detection of the sealing that it is desired to put in place, for example based on the derivative with respect to time of the pressure P in the secondary insulation space, namely ΔP/Δt, where ΔP represents a variation in the pressure in the secondary space during a time increment Δt, of which the duration is at least 30 min and can be combined until a sliding duration of up to 48 h or more is reached. Preferably, the criterion should take account of the degassing of the materials present in the secondary space (for example reinforced polyurethane foam) and/or of an increase in the concentration of O₂, and also the influence of variation of external temperatures associated with the day/night cycles and/or with the weather on the average temperature of the secondary insulation space and consequently on the pressure P in the secondary insulation space.

According to embodiments, the gaseous composition includes at least one main chemical species selected from the group constituted of: dinitrogen, carbon dioxide and argon.

According to embodiments, said or each main chemical species is selected from the group constituted of: dinitrogen, carbon dioxide and argon.

The triple point of dinitrogen is situated at 12.5 kPa at 64K. The triple point of carbon dioxide is situated at 519 kPa at 217K. The triple point of argon is situated at 68.7 kPa at 83.75K.

The primary thermally insulating barrier has to ensure that the service temperature of the secondary membrane remains higher than the condensation point of the one or more main chemical species at the service pressure. In particular, if the main chemical species is carbon dioxide, this condensation point is close to −80° C. for a service pressure close to atmospheric pressure. For example, the primary thermally insulating barrier may be designed so that the service temperature of the secondary membrane is normally close to −50° C.

According to one embodiment, the main chemical species includes carbon dioxide, carbon dioxide constituting at least 33% by volume of the secondary gaseous phase, preferentially at least 89% by volume of the secondary gaseous phase, even more preferably at least 99.4% by volume of the secondary gaseous phase. For example, carbon dioxide constitutes 90%, 91%, 92%, 93%, 94%, 95%, 96%, 97%, 98% or 99% by volume of the secondary gaseous phase.

Thus, the higher the percentage by volume of carbon dioxide in the secondary gaseous phase, the more the risk of condensation into liquid phase of other gases present in the secondary gaseous phase, in response to a temperature decrease, decreases.

According to one embodiment, the main chemical species includes argon, it being possible for argon to constitute at least 50% by volume of the secondary gaseous phase, preferentially at least 99% by volume of the secondary gaseous phase. This means that argon constitutes for example at least 60%, 70%, 80%, 90%, or 95% by volume of the secondary gaseous phase. In all cases, the partial pressure of argon of the secondary gaseous phase is lower than its triple point, i.e. 68.7 kPa.

According to one embodiment, the main chemical species includes dinitrogen, the partial pressure of the dinitrogen being lower than its triple point, i.e. 12.5 kPa.

According to one embodiment, the inerting device includes at least one gas source, the gas source having a gas reservoir filled with one said main species or a gas generator that is able to generate one said main species.

According to one embodiment, the gas source is a source of dinitrogen.

According to one embodiment, the gas source is a source of argon.

According to one embodiment, the gas source is a source of carbon dioxide.

According to one embodiment, the source of carbon dioxide comprises a carbon dioxide generator that is able to generate carbon dioxide from atmospheric air and a source of hydrocarbons, or preferably a pressurized carbon dioxide reservoir.

According to one embodiment, the inerting device includes a first gas source, the first gas source having a gas reservoir filled with a first said main species or a gas generator that is able to generate a first said main species, and a second gas source, the second gas source having a gas reservoir filled with a second said main species or a gas generator that is able to generate a second said main species.

According to one embodiment, the first gas source is the source of carbon dioxide and the second gas source is the source of dinitrogen.

According to one embodiment, the first gas source is the source of carbon dioxide and the second gas source is the source of argon.

According to one embodiment, the first gas source is the source of dinitrogen and the second gas source is the source of argon.

According to one embodiment, the primary space contains a primary gaseous phase having a pressure lower than the pressure of the secondary gaseous phase.

According to one embodiment, the primary space contains a primary gaseous phase having an absolute pressure lower than 1 Pa. By virtue of such placing under vacuum of the primary space, very good thermal insulation properties may be obtained.

According to one embodiment, the facility for storing and/or transporting liquefied hydrogen also has a pressure sensor that is able to detect a pressure in the secondary space and an alert device, the alert device being able to generate an alert in response to detection by the pressure sensor that the pressure of the secondary gaseous phase is below a pressure threshold.

By virtue of these features, it is possible to detect a drop in pressure in the secondary space that is likely to be caused by a leak of liquid hydrogen.

According to one embodiment, the primary thermally insulating barrier has a plurality of support pillars extending in a direction of the thickness of the primary thermally insulating barrier in order to maintain a distance between the secondary sealed membrane and the primary sealed membrane. By virtue of these features, it is possible to solidly support the primary sealed membrane so as to create an enhanced vacuum in the primary space without risking breaking the primary sealed membrane.

The secondary sealed membrane may be produced in different ways. According to one embodiment, the secondary membrane has a plurality of secondary undulations and flat portions situated between the secondary undulations, the flat portions resting on the secondary thermally insulating barrier.

According to one embodiment, the secondary membrane has a first series of undulations that are parallel and a second series of undulations that is perpendicular to the first series of undulations.

According to one embodiment, the secondary undulations protrude on the inner side of the secondary sealed membrane.

The secondary thermally insulating barrier may be produced in different ways. According to one embodiment, the secondary thermally insulating barrier has a plurality of juxtaposed insulating panels, the insulating panels bearing the secondary sealed membrane.

According to one embodiment, the insulating panels are self-supporting, i.e. the insulating panels sustain the vacuum. According to one embodiment, an insulating panel comprises a box made of plywood containing insulating material, for example a polyurethane (PU) foam, optionally reinforced with fibres.

According to one embodiment, the facility also has:
at least one supply line connected to the gas source and opening into the secondary space, and
at least one discharge line opening into the secondary space. For example, the supply line and/or the discharge line passes through the load-bearing structure so as to open into the secondary space. A vacuum pump can be connected to the discharge line in a temporary manner for an initial purge phase, for example via a flexible connector, and then disconnected.

According to one embodiment, the facility for storing and/or transporting a liquefied gas, preferentially liquefied hydrogen, also has a measuring device that is able to measure:
a quantity of the or each main chemical species injected into the secondary gaseous phase via the at least one supply line,
a quantity of gas extracted from the secondary space via the at least one discharge line,
   and that is able to emit an alert in response to the detection that a difference between the quantity of the or each main chemical species injected and the quantity of gas extracted exceeds a positive quantity threshold.

According to embodiments, the tank can have a spherical, cylindrical, polyhedral or prismatic overall shape.

According to a second object, the invention provides a method for operating a facility as described above, involving:

an injection step in which the or each main chemical species is injected in gaseous phase until the secondary gaseous phase is at an absolute pressure higher than 10 kPa, wherein the partial pressure of the or each main chemical species is lower than the triple point of said main chemical species, and wherein the partial pressure of the or each residual chemical species is lower than 0.14 kPa.

According to one embodiment, the injection step also involves the injection of the one or more main chemical species at an absolute pressure strictly lower than 95 kPa.

This specific range of absolute pressure of the secondary gaseous phase makes it possible to:
keep the gaseous composition in the gaseous state while conserving the turbulent to laminar flow properties in order not to increase the resistance to the free circulation of the gaseous composition in the insulation space that would be caused by the passage towards transient flow regimes with the molecular flow, and
put in place a negative relative pressure in the secondary insulation space in order to detect defective sealing of the external sealed wall by monitoring the rise in pressure beyond a criterion. This criterion could be a threshold maximum pressure not to be exceeded.

According to one embodiment, the operating method also involves a step of discharging the secondary gaseous phase during which a vacuum pump connected to the discharge line is activated. Preferably, in this case, the vacuum pump is activated in order to place the secondary space at an absolute pressure lower than 10 kPa, preferably lower than 1 kPa, in the step of discharging the secondary gaseous phase, the injection step being carried out after the step of discharging the secondary gaseous phase.

According to one embodiment of the operating method, the absolute pressure of the secondary gaseous phase is lower than 40 kPa during the steps of suction of the secondary gaseous phase and injection.

According to one embodiment of the operating method, the steps of discharging the secondary gaseous phase and injection are carried out in a repeated manner.

Thus, the steps of discharging the secondary gaseous phase and injection, for example of carbon dioxide, can be carried out as often as necessary, for example depending on the measurements provided by a gas analyser connected to the secondary space.

According to one embodiment of the operating method, the injection step is carried out so as to create a circulation of the secondary gaseous phase that makes it possible to renew the secondary gaseous phase.

Such an operating method can be carried out under temperature and pressure conditions for operating the facility, i.e. the tank contains liquefied gas and preferentially the tank contains liquefied hydrogen. According to one embodiment, the method is carried out when the liquid hydrogen fills at least 10% of the volume of the tank, for example 50% of this volume.

Such a facility can form part of an onshore or submerged storage facility, or be installed in a floating, coastal or deep water structure, in particular a ship, a floating storage and regasification unit (FSRU), a floating production storage and offloading unit (FPSO), and the like. Such a facility can also be used as a fuel reservoir in any type of onshore vehicle or ship.

According to one embodiment, a ship for transporting a liquid gas, preferentially liquid hydrogen, has a double hull and an aforementioned facility disposed in the double hull.

According to one embodiment, the invention also provides a system for transferring a liquefied gas, preferentially liquid hydrogen, the system having such a ship, insulated pipelines arranged so as to connect the sealed and thermally insulating tank disposed in the hull of the ship to a floating or onshore storage facility and a pump for driving a stream of liquid gas, preferentially liquid hydrogen, through the insulated pipelines from or to the floating or onshore storage facility to or from the sealed and thermally insulating tank disposed in the hull of the ship.

According to one embodiment, the invention also provides a method for loading or offloading from such a ship, wherein the liquid gas, preferentially liquid hydrogen, is conveyed through the insulated pipelines from or to a floating or onshore storage facility to or from the sealed and thermally insulating tank disposed in the hull of the ship.

### BRIEF DESCRIPTION OF THE FIGURES

The invention will be better understood, and further aims, details, features and advantages thereof will become more clearly apparent in the course of the following description of a number of particular embodiments of the invention, which are given solely by way of illustration and without limitation, with reference to the appended drawings.

FIG. 1 shows a schematic view of a facility according to one embodiment.

FIG. 2 is a sectional view of a multilayer structure that can be used to produce a tank wall in the facility in FIG. 1.

FIG. 3 is a schematic cut-away depiction of a ship having a tank for transporting liquefied gas and of a terminal for loading/offloading from this tank.

FIG. 4 illustrates a carbon dioxide phase diagram.

FIG. 5 illustrates a schematic view of a facility according to another embodiment.

FIG. 6 shows a sectional view of another embodiment of a facility according to the invention.

### DESCRIPTION OF THE EMBODIMENTS

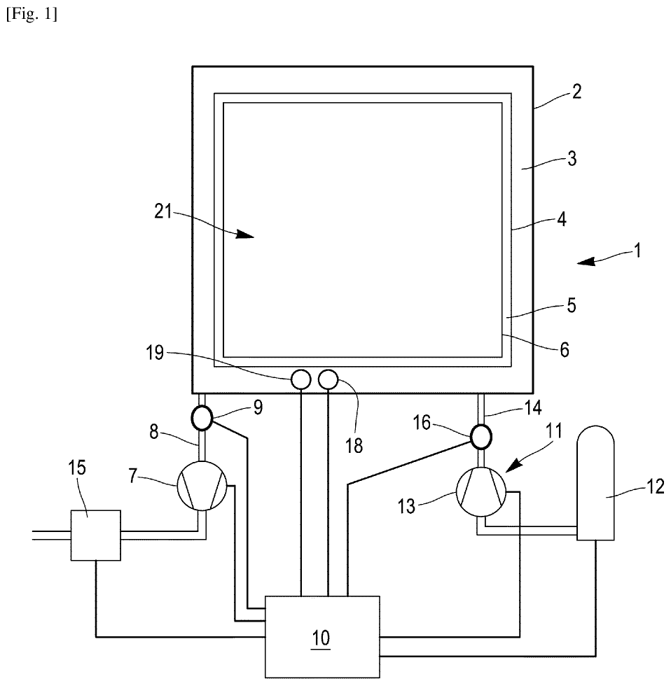

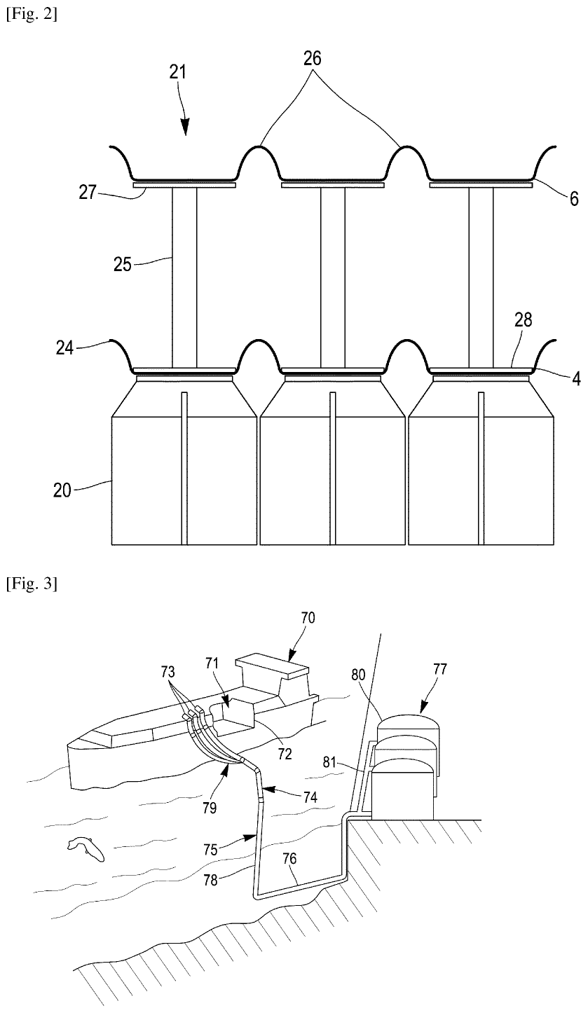

With reference to FIGS. 1 and 2, a facility for storing and/or transporting liquefied gas, preferentially liquefied hydrogen, has a sealed and thermally insulating tank 1.

The sealed and thermally insulating tank 1 is a membrane-type tank that makes it possible to store a liquefied gas, for example liquid hydrogen. The tank 1 has a multilayer structure that has, from the outside towards the inside, a secondary thermally insulating barrier 3, having for example insulating elements 20 shown in FIG. 2, resting against a load-bearing structure 2, a secondary sealing membrane 4 resting against the secondary thermally insulating barrier 3, a primary thermally insulating barrier 5, resting against the secondary sealing membrane 4, and a primary sealing membrane 6 in contact with the liquefied gas contained in the tank 1. The primary sealing membrane 6 defines an internal space 21 intended to contain the liquefied gas, preferentially intended to contain liquid hydrogen.

As can be seen in FIG. 2, the primary membrane 6 and the secondary membrane 4 are corrugated and respectively have primary undulations 26 and secondary undulations 24 protruding in the direction of the internal space 21 of the tank 1.

A primary space is defined by the space situated between the secondary sealed membrane 4 and the primary sealed membrane 6. The primary space has the primary thermally insulating barrier 5.

The primary insulating barrier 4 has a plurality of support pillars 25 extending in a direction of the thickness of the primary thermally insulating barrier 5 in order to maintain a distance between the secondary sealed membrane 4 and the primary sealed membrane 6. Each support pillar 25 has a first flat end 27 that is in contact with the primary membrane 6, between two primary undulations 26, and a second flat end 28 that is in contact with the secondary membrane 4, between two secondary undulations 24. The first and the second flat ends 27, 28 are situated facing one another. The primary space is placed under enhanced vacuum, for example at a pressure lower than 1 Pa, in order to increase the thermal insulation of the primary thermally insulating barrier 5.

The tank 1 also has a secondary space that is defined by the space situated between the load-bearing structure 2 and the secondary sealed membrane 4. The secondary space has the secondary thermally insulating barrier 3 and a secondary gaseous phase that will be described below.

The secondary thermally insulating barrier 3 has self-supporting insulating panels 20, for example reinforced polyurethane foam. For example, the self-supporting insulating panels 20 have two rigid plates made of plywood that sandwich polyurethane foam.

In service, the secondary gaseous phase is composed essentially of carbon dioxide or other gaseous compositions described in the examples. In order to produce and maintain the secondary gaseous phase, an inerting device 11 schematically shown in FIG. 1 can be employed. The secondary gaseous phase is kept for example at a pressure close to atmospheric pressure.

The inerting device 11 has a source of carbon dioxide 12, for example a pressurized reservoir, connected to a supply line 14 passing through the load-bearing structure 2 and opening into the secondary space. A compressor 13 can be provided so as to carry out a forced injection of carbon dioxide from the source of carbon dioxide 12 into the secondary space.

The inerting device 11 also has a discharge line 8 passing through the load-bearing structure 2 and opening into the secondary space. Optionally, a vacuum pump 7 is connected to the discharge line 8. The vacuum pump 7 can be connected to a gas analyser 15 that is configured to detect the composition of the secondary gaseous phase. The gas analyser 15 is in this case placed at the outlet of the vacuum pump 7. The gas analyser 15 can in particular have a mass spectrometer.

In addition, flowmeters 9 and 16 may be provided to measure respectively a flow rate of gas leaving the secondary space via the discharge line 8 and a flow rate of gas entering the secondary space via the supply line 14.

A pressure sensor 18 is provided to measure the pressure in the secondary space and a temperature sensor 19 is provided to measure the temperature in the secondary space.

A control unit 10 may be used to control the various actuators of the inerting device 11, namely the compressor 13, the source of carbon dioxide 12 and the vacuum pump 7, and receive the measurement signals from the various sensors, namely the gas analyser 15, the flowmeters 9 and 16, and the pressure sensor 18 and temperature sensor 19.

Other aspects of the inerting device 11 may be realized in a manner similar to the nitrogen distribution system described in document WO2015155377A1.

Filling the internal space 21 with liquid hydrogen leads to a decrease in the temperature of the primary membrane 6, of the primary space, of the secondary membrane 4 and finally of the secondary space. Thus, the temperature of the secondary membrane 4 is approximately −30° C. to −70° C. Δt this temperature the carbon dioxide does not condense.

If a liquid hydrogen leak occurs in the primary membrane 6, the temperature of the secondary member 4 will drop below −80° C. at a cold point corresponding to the zone where the liquid hydrogen has flowed. Thus, in the secondary space, at this cold point, the carbon dioxide will condense into solid phase without passing through the liquid phase and will form icicles attached to the secondary membrane 4, for example inside the secondary undulations 24.

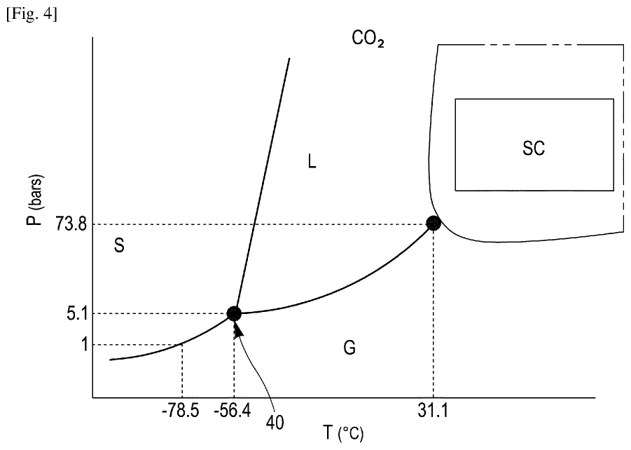

This phenomenon is explained in relation to FIG. 4 illustrating a CO₂ phase diagram. The CO₂ in gaseous phase G is kept at a pressure P below its triple point 40. Thus, in the event of the temperature T decreasing below a certain threshold, the CO₂ will condense into solid phase S without passing through the liquid phase L.

By virtue of the flowmeters 9 and 16, the control unit 10 can determine the quantity of gas discharged from the secondary space via the discharge line 8 and the quantity of carbon dioxide injected into the secondary space via the supply line 14.

In order to produce the secondary gaseous phase, and then renew it over time, intermittent or continuous inerting methods can be employed, for example under the direction of the control unit 10.

A first inerting method involves the following steps:
discharging the secondary gaseous phase, which may initially be constituted of ambient air, via the discharge line 8 with the vacuum pump 7,
   then, once the secondary gaseous phase has been discharged as far as a sufficiently low pressure, for example 1 kPa, stopping the vacuum pump and then,
injecting carbon dioxide via the carbon dioxide source 12 and if appropriate the compressor 13 until the service pressure, which is for example equal to atmospheric pressure, is reached.

This method can be repeated multiple times until the secondary gaseous phase is composed of at least 99.4% carbon dioxide by volume, the remainder being residual ambient air of which the partial pressure, in particular that of the residual oxygen, will be so low that the risk of explosion is decreased. If gases are released over time by the material present in the secondary thermally insulating barrier 3, it may be necessary to repeat this method multiple times.

In another inerting method that can be used, the secondary gaseous phase is renewed by flushing. The method then involves the following steps:
injecting carbon dioxide into the secondary space via the source of carbon dioxide 12, and if appropriate the compressor 13, in order to create a circulation of the secondary gaseous phase. The carbon dioxide 12 will push the secondary gaseous phase present in the secondary space towards the discharge line in order to discharge the gaseous phase towards the outside of the secondary space and in order to replace said secondary gaseous phase. In this method, it is not necessary for a vacuum pump to be connected to the discharge line 8.

This method of inerting by flushing can be automated and implemented by an automated device that automatically triggers the injection of carbon dioxide into the secondary space depending on a pressure measurement taken in the secondary space. Thus, the secondary space may be supplied with carbon dioxide with regulation to +/−0.5 kPa around a fixed pressure setpoint.

The control unit 10 can also have alert functions. For example, the control unit 10 emits alerts in the following cases, which constitute probable cases of leakage of liquid hydrogen:
the pressure detector 18 indicates that the pressure in the secondary space has passed below a pressure threshold. Specifically, the condensation of the carbon dioxide into solid phase will lead to a decrease in the pressure in the secondary space. By way of example, assuming that the secondary space is insulated, has a volume of 68 m³ of free, non-partitioned volume and has a gaseous composition containing a partial pressure of CO₂ of 100 kPa and an average temperature of 0° C. under normal operating conditions of the tank, then in the event of formation of a cold point involving the condensation in equilibrium of 3 litres of CO₂ into solid phase, the drop in pressure provided by this mechanism alone is 2.5 kPa in the secondary space. Thus, in this example, if the pressure sensor 18 detects a decrease in pressure of 2.5 kPa, then the control unit 10 can generate an alert.
the quantity of gas injected into the secondary space over a period of time has exceeded, by a certain threshold, the quantity of gas discharged over the same period of time. Specifically, an accumulation of carbon dioxide in the secondary space may be caused by the presence of an abnormal cold point.

Examples of preferred gaseous compositions that can be used to inert the secondary space according to embodiments are described below.

TABLE 1

| Example | | |
|---|---|---|
| 1 | Chemical species | volume |

| | |
|---|---|
| carbon dioxide | 89% |
| dinitrogen | 11% |
| secondary | ? % |

In Example 1, the residual chemical species may include atmospheric dioxygen.

TABLE 2

| | | |
|---|---|---|
| Example 2 | Chemical species | by volume |

| | |
|---|---|
| argon | >99% |
| other | <1% |

In Example 2, the total pressure is lower than the triple point of argon, which is situated at 68.7 kPa.

TABLE 3

| | | |
|---|---|---|
| Example 3 | Chemical species | by volume |

| | |
|---|---|
| dinitrogen | >99% |
| other | <1% |

In Example 3, the total pressure is lower than 13 kPa, which is the triple point of dinitrogen.

For the gaseous compositions in Examples 1 to 3, an inerting device having a gas source may be employed in a manner similar to the embodiment that is illustrated in FIG. 1. The gas source has to be adapted depending on the gaseous composition that it is desired to obtain. For Example 1 the gas source is a source of carbon dioxide, for Example 2 the gas source is a source of argon and for Example 3, the gas source is a source of dinitrogen.

TABLE 4

| | | |
|---|---|---|
| Example 4 | Chemical species | by volume |

| | |
|---|---|
| carbon dioxide | 89% |
| dinitrogen | 11% |

In Example 4, the total pressure is lower than or equal to atmospheric pressure.

TABLE 5

| | | |
|---|---|---|
| | | by |
| Example 5 | Chemical species | volume |

| | |
|---|---|
| Argon | 59.7% |
| carbon dioxide | 39.8% |
| other | 0.5% |

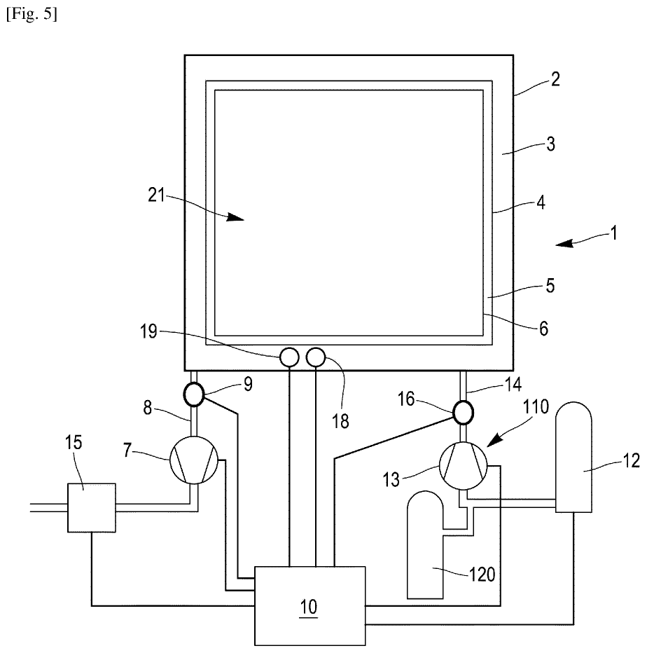

For the gaseous compositions in Examples 4 and 5, an inerting device 110 as illustrated in FIG. 5 can be used. Identical or similar elements have the same reference numerals as in FIG. 1. The inerting device 110 differs from the inerting device 11 in FIG. 1 in that the gas source 12 is a first gas source and the inerting device 110 also has a second gas source 120.

For Example 4, the first gas source 12 is a source of carbon dioxide and the second gas source 120 is a source of dinitrogen.

For Example 5, the first gas source 12 is a source of argon and the second gas source 120 is a source of carbon dioxide.

The first main species contained in the first reservoir of the first gas source 12 and the second main species contained in the second reservoir of the second gas source 120 can be injected into the secondary space via one or more supply lines. Furthermore, one or more valves may be placed on the supply line 14, for example at the gas outlet of the first gas source 12 and/or of the second gas source 120. The flow rate or the quantity of gas injected via the first gas source 12 or the second gas source 120 may be controlled by the control unit 10, which controls for example the valves situated at the gas outlet of the first gas source 12 or of the second gas source 120.

With reference to FIG. 3, a cut-away view of a ship 70 shows a facility comprising a sealed and thermally insulating tank 71 with a prismatic overall shape assembled in the double hull 72 of the ship. The wall of the tank 71 has a primary sealing membrane that is in contact with the liquid hydrogen contained in the tank, a secondary sealing membrane arranged between the primary sealing membrane and the double hull 72 of the ship, and two thermally insulating barriers arranged between the primary sealing membrane and the secondary sealing membrane and between the secondary sealing membrane and the double hull 72, respectively.

In a manner known per se, loading/offloading pipelines 73 disposed on the upper deck of the ship can be connected, by means of appropriate connectors, to a maritime or port terminal in order to transfer a cargo of hydrogen from or to the tank 71.

FIG. 3 shows an example of a maritime terminal having a loading and offloading station 75, an underwater pipe 76 and an onshore facility 77. The loading and offloading station 75 is a fixed offshore facility comprising a mobile arm 74 and a tower 78 that supports the mobile arm 74. The mobile arm 74 bears a bundle of insulated flexible hoses 79 that can be connected to the loading/offloading pipelines 73. The orientable mobile arm 74 adapts to all sizes of ship. A connecting pipe, not shown, extends inside the tower 78.

The loading and offloading station 75 allows the ship 70 to be loaded and offloaded from or to the onshore facility 77. The latter has liquid hydrogen storage tanks 80 and connecting pipes 81 that are connected via the underwater pipe 76 to the loading or offloading station 75. The underwater pipe 76 allows the transfer of the liquid hydrogen between the loading or offloading station 75 and the onshore facility 77 over a long distance, for example 5 km, and this makes it possible to keep the tanker 70 at a long distance from the coast during the loading and offloading operations.

In order to generate the pressure necessary for the transfer of the liquid hydrogen, pumps on board the ship 70 and/or pumps with which the onshore facility 77 is equipped and/or pumps with which the loading and offloading station 75 is equipped are used.

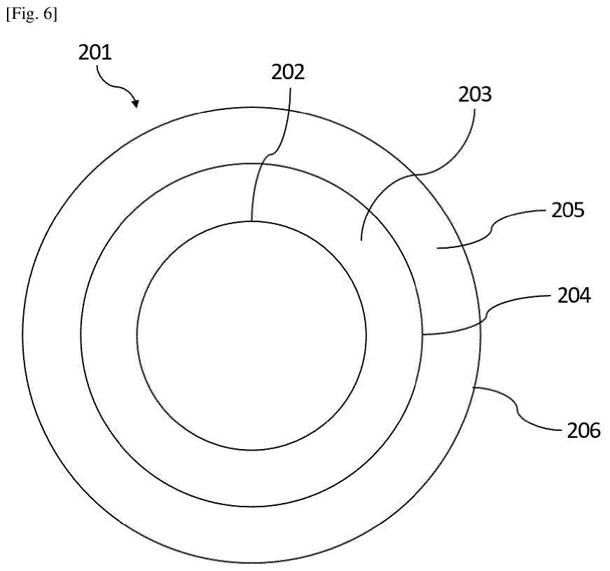

Similarly, the invention also relates to a facility for transferring a liquefied gas, preferentially liquefied hydrogen. Such a facility may be seen as a liquefied gas transfer pipe and is also known by the term “pipe in pipe”. FIG. 6 shows a sectional view of such a facility (the inerting device is not shown there). Said facility has a container in the form of a transfer pipe 201, the transfer pipe 201 comprises, from the inside of the facility towards the outside of the facility:
a primary sealed pipeline 202, the primary sealed pipeline 202 being intended to be in contact with the liquefied gas, preferentially the liquefied hydrogen, contained in the inner space of the primary sealed pipeline 202 so as to ensure the transfer thereof,
   a secondary sealed wall 204 situated at a distance from an outer side of the primary sealed pipeline 202 and defining a primary space between the primary sealed pipeline 202 and the secondary sealed membrane 204,
   a primary thermally insulating barrier 203 disposed in the primary space,
   an external sealed wall 206 situated at a distance from the secondary sealed wall 204, and defining a secondary space between the external sealed wall 206 and the secondary sealed wall 204,
   a secondary thermally insulating barrier 205 and a secondary gaseous phase, which are disposed in the secondary space (defined between the secondary sealed wall 204 and the external sealed wall 206), the external wall 206 being borne by the secondary thermally insulating barrier 205,
   said facility having an inerting device 11, 110 connected, at least temporarily, to the secondary space so as to keep and/or place the secondary gaseous phase in the form of a gaseous composition constituted of one or more main chemical species, and optionally one or more residual chemical species,
   the inerting device being configured to keep the secondary gaseous phase at an absolute pressure higher than 10 kPa, wherein the partial pressure of the or each main chemical species is lower than the triple point of said main chemical species,
   and wherein the partial pressure of the or each residual chemical species is lower than 0.14 kPa.

The inerting device 11, 110 is also configured to keep the secondary gaseous phase at an absolute pressure strictly lower than 95 kPa.

The transfer pipe 201 extends over a length L and is open at its ends for the transfer of the liquefied gas along the transfer pipe 201, inside the pipeline 202. The pipeline 202 is intended to convey the liquefied gas from one end of the transfer pipe 201 to the other end of the transfer pipe 201.

The same principle of the invention in connection with the inerting described in detail in an embodiment with a tank applies to a pipe of “pipe in pipe” type. The inerting is advantageously carried out in a temporary manner so as to place the secondary gaseous phase at the right level of pressure.

Advantageously, the secondary space is at a raised pressure with respect to atmospheric pressure. This embodiment is made possible by the fact that the walls of the “pipe in pipe” facility have a certain stiffness allowing this maintaining of the raised pressure.

Although the invention has been described in connection with a number of particular embodiments, it is obvious that it is in no way limited thereto and that it comprises all the technical equivalents of the means described and the combinations thereof, if these fall within the scope of the invention.

The use of the verb “to have”, “to comprise” or “to include” and of the conjugated forms thereof does not exclude the presence of elements or of steps other than those mentioned in a claim.

In the claims, any reference sign between parentheses should not be interpreted as limiting the claim.

1. A facility for storing, transporting, and/or transferring a liquefied gas, said facility having a sealed and thermally insulating container (1, 201), the sealed and thermally insulating container comprising:
a sealed external wall (2; 206),
a secondary sealed membrane (4; 204) situated at a distance from an inner side of the external wall (2; 206) and defining a secondary space between the external wall (2; 206) and the secondary sealed membrane (4; 204),
a secondary thermally insulating barrier (3; 205) and a secondary gaseous phase that are disposed in the secondary space, the secondary space being delimited by the external wall (2; 206), the secondary sealed membrane (4; 204) being borne by the secondary thermally insulating barrier (3; 205),
a primary sealed membrane (6; 202) situated at a distance from an inner side of the secondary sealed membrane (4; 204) and defining a primary space between the secondary sealed membrane (4; 204) and the primary sealed membrane, the primary sealed membrane for contact with the liquefied gas, contained in the sealed and thermally insulating container,
a primary thermally insulating barrier (5; 203) disposed in the primary space, the primary sealed membrane (6; 202) being borne by the primary thermally insulating barrier (5; 203),
said facility having an inerting device (11, 110) connected to the secondary space so as to keep the secondary gaseous phase in the form of a gaseous composition constituted of one or more main chemical species, and optionally one or more residual chemical species,
the inerting configured to keep the secondary gaseous phase at an absolute pressure higher than 10 kPa and strictly lower than 95 kPa, wherein the partial pressure of the or each main chemical species is lower than the triple point of said main chemical species, and
wherein the partial pressure of the or each residual chemical species is lower than 0.14 kPa,
wherein the inerting device includes at least one gas source (12), the gas source having a gas reservoir filled with one said main species or a gas generator that is able to generate one said main species,
the facility also having:
at least one supply line (14) connected to the gas source (12, 120) and opening into the secondary space,
at least one discharge line (8) opening into the secondary space, and
a measuring device (9, 16, 10) for measuring:
a quantity of the or each main chemical species injected into the secondary gaseous phase via the at least one supply line, and
a quantity of gas extracted from the secondary space via the at least one discharge line, and
wherein the measuring device (9, 16, 10) emits an alert in response to the detection that a difference between the quantity of the or each main chemical species injected and the quantity of gas extracted exceeds a positive quantity threshold.

2. The facility according to claim 1, wherein the sealed and thermally insulating container is a sealed and thermally insulating tank, the external wall being a load-bearing structure (2) and the secondary thermally insulating barrier (3) being anchored to the load-bearing structure (2).

3. The facility according to claim 1, wherein said gaseous composition includes at least one main chemical species selected from the group constituted of: dinitrogen, carbon dioxide and argon.

4. The facility according to claim 3, wherein said or each main chemical species is selected from the group constituted of: dinitrogen, carbon dioxide and argon.

5. The facility according to claim 1, wherein said main chemical species includes carbon dioxide, carbon dioxide constituting at least 33% by volume of the secondary gaseous phase.

6. The facility according to claim 1, wherein said main chemical species includes argon, the partial pressure of the argon being lower than its triple point.

7. The facility according to claim 6, wherein argon constitutes at least 50% by volume of the secondary gaseous phase.

8. The facility according to claim 1, wherein said main chemical species includes dinitrogen, the partial pressure of the dinitrogen being lower than its triple point.

9. The facility according to claim 1, wherein the primary space contains a primary gaseous phase having a pressure lower than the pressure of the secondary gaseous phase.

10. The facility according to claim 1, wherein the primary space contains a primary gaseous phase having an absolute pressure lower than 1 Pa.

11. The facility according to claim 1, further comprising:
a pressure sensor (18) for detecting a pressure in the secondary space, and
an alert device (10) for generating an alert in response to detection by the pressure sensor that the pressure of the secondary gaseous phase is below a pressure threshold.

12. The facility according to claim 1, wherein the primary thermally insulating barrier (5) has a plurality of support pillars (25) extending in a direction of the thickness of the primary thermally insulating barrier (5) in order to maintain a distance between the secondary sealed membrane (4) and the primary sealed membrane (6).

13. The facility according to claim 1, wherein the secondary sealed membrane (4) has a plurality of secondary undulations (24) and flat portions situated between the secondary undulations, the flat portions resting on the secondary thermally insulating barrier (3), wherein the secondary undulations protrude on the inner side of the secondary sealed membrane (4).

14. The facility according to claim 1, wherein the inerting device includes:
a first gas source (12), the first gas source (12) having a gas reservoir filled with a first said main species or a gas generator that is able to generate a first said main species, and
a second gas source (120), the second gas source (120) having a gas reservoir filled with a second said main species or a gas generator that is able to generate a second said main species.

15. A method for operating a facility according to claim 1, comprising
an injection step in which the or each main chemical species is injected in gaseous phase until the secondary gaseous phase is at an absolute pressure higher than 10 kPa and strictly lower than 95 kPa, wherein the partial pressure of the or each main chemical species is lower than the triple point of said main chemical species, and wherein the partial pressure of the or each residual chemical species is lower than 0.14 kPa.

16. The method according to claim 15, further comprising a step of discharging the secondary gaseous phase during which a vacuum pump (7) is connected to the discharge line (8) and activated, wherein the vacuum pump (7) is activated in order to place the secondary space at an absolute pressure lower than 10 kPa, in the step of discharging the secondary gaseous phase, the injection step being carried out after the step of discharging the secondary gaseous phase.

17. The method according to claim 16, wherein the steps of discharging the secondary gaseous phase and injection are carried out in a repeated manner.

18. The method according to claim 15, wherein the injection step is carried out so as to create a circulation of the secondary gaseous phase that makes it possible to renew the secondary gaseous phase.

19. The method according to claim 16, wherein the absolute pressure of the secondary gaseous phase is lower than 40 kPa during the steps of suction of the secondary gaseous phase and injection.

20. A ship (70) for transporting a liquid gas, the ship having a double hull (72) and a facility according to claim 1 disposed in the double hull, and wherein the sealed and thermally insulating container is a sealed and thermally insulating tank, the external wall being a load-bearing structure (2) and the secondary thermally insulating barrier (3) being anchored to the load-bearing structure (2).

21. A system for transferring a liquefied gas, the system having a ship (70) according to claim 20, insulated pipelines (73, 79, 76, 81) arranged so as to connect the sealed and thermally insulating tank (71) disposed in the hull of the ship to a floating or onshore storage facility (77) and a pump for driving a stream of a liquefied gas, through the insulated pipelines from or to the floating or onshore storage facility to or from the sealed and thermally insulating tank disposed in the hull of the ship.

22. A method for loading or offloading from a ship (70) according to claim 20, wherein a liquefied gas, is conveyed through the insulated pipelines (73, 79, 76, 81) from or to a floating or onshore storage facility (77) to or from the sealed and thermally insulating tank (71) disposed in the hull of the ship.
